(19) United States
(12) Patent Application Publication
(10) Pub. No.: US 2026/0185849 A1
(43) Pub. Date: Jul. 2, 2026

(54) VEHICLES, COMPUTER APPARATUSES AND METHODS FOR GENERATING A TRAJECTORY OF A VEHICLE ON A MAP

(71) Applicant: Toyota Jidosha Kabushiki Kaisha, Toyota-shi Aichi-ken (JP)

(72) Inventor: Alexander C. Schaefer, Fremont, CA (US)

(73) Assignee: Toyota Jidosha Kabushiki Kaisha, Toyota-shi Aichi-ken (JP)

(21) Appl. No.: 19/005,305

(22) Filed: Dec. 30, 2024

(51) Int. Cl. G01C 21/00; B60W 60/00

(52) U.S. Cl. CPC G01C 21/3844; B60W 60/001

(57) ABSTRACT

In one embodiment, a method of generating a trajectory of a vehicle on a map includes receiving map data of the map, wherein the map data includes a first road and a second road. The method further includes receiving odometry data from one or more sensors of the vehicle, the odometry data having an odometry uncertainty associated therewith, and receiving a plurality of vehicle location signals, each vehicle location signal having a location uncertainty associated therewith. The method also includes generating the trajectory of the vehicle on the first road or the second road of the map by providing as input to an optimizer the odometry uncertainty and the location uncertainty of the plurality of vehicle location signals as constraints.

### BACKGROUND

High definition (HD) maps contain a significant amount of information and are highly accurate. HD maps are captured using lidar, cameras, radar, GPS and the like. HD maps typically include detailed information, such as lane information. These HD maps are used by autonomous vehicles to navigate the environment.

On the other hand, a standard definition (SD) map has basic information regarding road location, intersections, and other information. A majority of mapping information available today is in the form of SD maps. Another type of map is an enhanced SD map that includes all of the information of an SD map with the addition of additional road attributes, such as the number of lanes and their travel directions. Although HD maps provide great value, they are large in size, expensive to develop, and not always available.

Global navigation satellite system (GNSS) measurements (i.e., global positioning system (GPS) measurements) can be noisy and not always accurate. For example, a GNSS measurement may indicate that a vehicle is several meters off of a road when in fact the vehicle is traveling on the road. The noisiness of GNSS signals make it very difficult for the control system of the vehicle to localize the vehicle on the map, and particularly an SD map wherein the detailed information of an HD map is not available. For example, the vehicle may be localized on the wrong road of the map, particularly when there is an intersection, or when there are roads adjacent to one another. It may also be difficult in environments where GNSS signals are particularly noisy, such as in urban environments. Because it is difficult to localize a vehicle on a map, it is also difficult to construct an accurate trajectory that a vehicle took on the map.

Accordingly, alternative systems and methods for localizing a vehicle on a map and estimating a trajectory of the vehicle may be desired.

### SUMMARY

In one embodiment, a method of generating a trajectory of a vehicle on a map includes receiving map data of the map, wherein the map data includes a first road and a second road. The method further includes receiving odometry data from one or more sensors of the vehicle, the odometry data having an odometry uncertainty associated therewith, and receiving a plurality of vehicle location signals, each vehicle location signal having a location uncertainty associated therewith. The method also includes generating the trajectory of the vehicle on the first road or the second road of the map by providing as input to an optimizer the odometry uncertainty and the location uncertainty of the plurality of vehicle location signals as constraints.

In another embodiment, a vehicle includes one or more processors, one or more sensors, and a non-transitory memory storing instructions that, when executed by the one or more processors, configure the vehicle to receive map data of the map, wherein the map data includes a first road and a second road. The instructions further cause the one or more processors to receive odometry data from one or more sensors of the vehicle, the odometry data having an odometry uncertainty associated therewith, receive a plurality of vehicle location signals, each vehicle location signal having a location uncertainty associated therewith, and generate the trajectory of the vehicle on the first road or the second road of the map by providing as input to an optimizer the odometry uncertainty and the location uncertainty of the plurality of vehicle location signals as constraints.

In another embodiment, a computing apparatus includes one or more processors and a non-transitory memory storing instructions that, when executed by the processor, configure the computing apparatus to receive map data of the map that includes a first road and a second road, receive odometry data from one or more sensors of the vehicle, the odometry data having an odometry uncertainty associated therewith, receive a plurality of vehicle location signals, each vehicle location signal having a location uncertainty associated therewith, and generate the trajectory of the vehicle on the first road or the second road of the map by providing as input to an optimizer the odometry uncertainty and the location uncertainty of the plurality of vehicle location signals as constraints.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE SEVERAL VIEWS OF THE DRAWINGS

FIG. 1 illustrates an environment having an intersection of roads.

FIG. 2 illustrates an example map of the environment depicted by FIG. 1 according to one or more embodiments described and illustrated herein.

FIG. 3 illustrates an example vehicle according to one or more embodiments described and illustrated herein.

FIG. 4 illustrates the example map of FIG. 2 having sensor data and associated probabilities depicted thereon according to one or more embodiments described and illustrated herein.

FIG. 5 illustrates an example workflow of generating a trajectory of a vehicle according to one or more embodiments described and illustrated herein.

FIG. 6 illustrates example components of a vehicle or computer apparatus capable of performing the functionality of generating a trajectory of a vehicle according to one or more embodiments described and illustrated herein.

FIG. 7 illustrates a flowchart of an example method for generating a trajectory of a vehicle according to one or more embodiments described and illustrated herein.

### DETAILED DESCRIPTION

Embodiments of the present disclosure are directed to solving the problem of generating a trajectory of a vehicle when the global navigation satellite system (GNSS) information is noisy and the proper localization of the vehicle is ambiguous. The accuracy of GNSS locations derived from GNSS signals may be low, particularly in urban settings where GNSS signals are known to bounce off of buildings and cause errors in location. This can cause the vehicle to be localized on the map at an incorrect location or road. For example, a vehicle may be traveling on a road close to a highway, but the GNSS location that is generated may place the vehicle on the highway rather than the road the vehicle is actually on. This can cause the vehicle to be localized on the wrong road in a navigation system and/or an autonomous driving system. Localizing the vehicle on the wrong road can create incorrect navigational guidance and/or incorrect autonomous control of the vehicle.

Generally, embodiments systems and methods for increasing the accuracy of determining vehicle trajectories by using the uncertainties associated with sensor data as inputs to an optimizer programmed to develop a trajectory that the vehicle takes on a map, such as an enhanced standard definition map (SD) map. It is noted that the word “trajectory” as used herein includes not only a geometric trajectory, but also topographical information, such as the associated road and position of the vehicle relative to the road in addition to the geometric position, which can be expressed by longitude, latitude and heading. More particularly, the vehicle receives vehicle location signals (i.e., GNSS signals) and generates a plurality of GNSS locations over time as the vehicle travels. These vehicle location signals may be noisy, and may have a location uncertainty associated therewith. For example, a vehicle location signal may be particularly noisy, and have a low probability of being accurate, while another vehicle location signal may be sharp, and have a high probability of being accurate. Further, the vehicle includes one or more sensors that gathers odometry data, such as a wheel sensors mounted on the wheel axles that produce vehicle orientation data. Odometry data in the form of heading data and distance data is generated. An odometry uncertainty signal is generated, which represents the uncertainty of the odometry data.

The location uncertainty and odometry uncertainty are provided as inputs into an optimizer (i.e., an optimization solver) as constraints that outputs an accurate actual trajectory of the vehicle.

Additional constraints may also be determined an inputted into the optimization solver. For example, for each GNSS location, the vehicle may generate a local map using sensor data, such as camera data. The local map includes the number of lanes, the lane direction, the lane width, the lane curvature, speed limit, as not limiting examples. For example, image data is used to detect the number of lanes in the road in which the vehicle is traveling. The number of lanes is provided in the local map for the particular GNSS location. The number of lanes of the local map and the number of lanes provided in the enhanced SD map may also be provided as inputs to the optimizer as constraints to output the actual trajectory of the vehicle on the map.

Accordingly, embodiments provide additional information that allows the vehicle to more accurately be localized on a map, particularly in environments where the GNSS signal is noisy.

Various embodiments of systems, methods, and vehicles for generating a trajectory of a vehicle on a map are described in detail below.

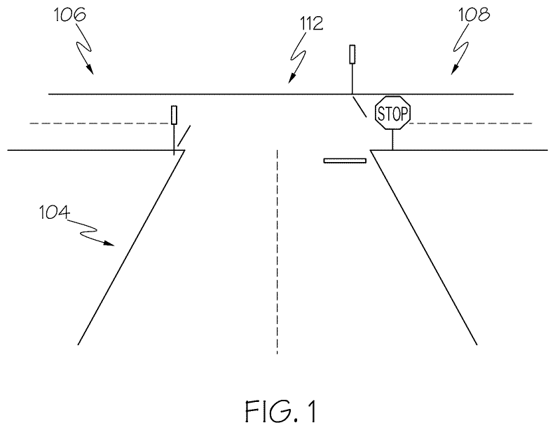

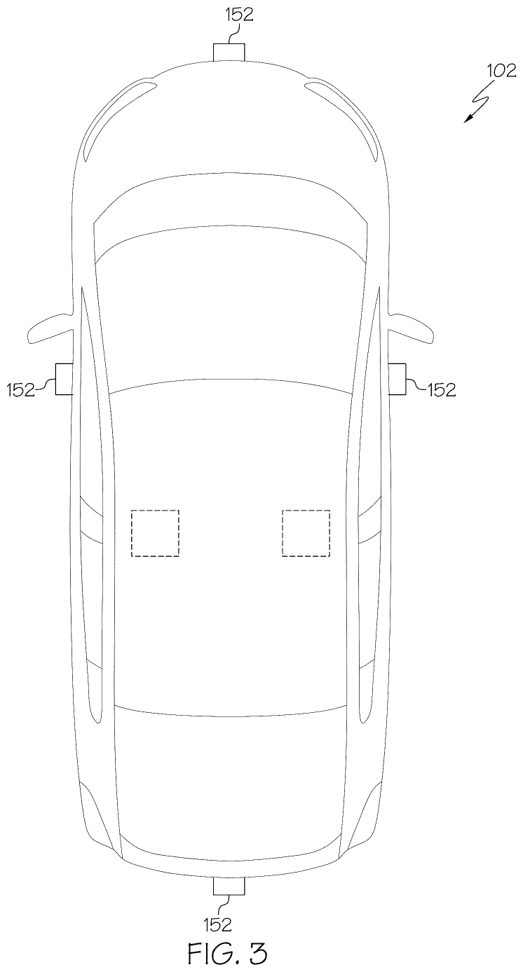

Referring now to FIG. 1, an example vehicular environment includes a vehicle 102 (see FIG. 3) where a first road 104, a second road 106 and a third road 108 meet at an intersection. The second road 106 and the third road 108 may define a single road that intersects with the first road 104, for example. When a vehicle approaches the intersection 112 from the first road 104, there is the option to turn right onto the third road 108 or to turn left onto the second road 106. It should be understood that the environment illustrated by FIG. 1 is for illustrative purposes only, and that embodiments of the present disclosure may be utilized in any intersection configuration. The vehicle 102 may be a driver-controlled vehicle, a semi-autonomous vehicle, or an autonomous vehicle. An example vehicle 102 is illustrated in FIG. 3 and described in more detail below. Such a vehicle 102 includes a GNSS device 154, such as a GPS receiver, that receives GNSS signals that define a location of the vehicle 102. However, as stated above, such GNSS signals may be noisy and not accurate.

In some embodiments, the vehicle 102 uses not only GNSS information for localization, but also other information generated by other sensors of the vehicle. For example, the vehicle 102 may use GNSS signals, odometry information, and inertial measurement unit (IMU) signals from IMU sensors. Further, in some embodiments the vehicle 102 generates a vehicle location signal by estimation without using a GNSS signal. It should be understood that while embodiments are described herein in the context of using GNSS signals, embodiments may use a vehicle location signal that may or may not use GNSS signals.

The vehicle 102 includes a mapping function whereby map data is loaded onto the memory of the vehicle 102 or provided remotely by a remote server. The map data may define an enhanced SD map that includes the number of lane lines.

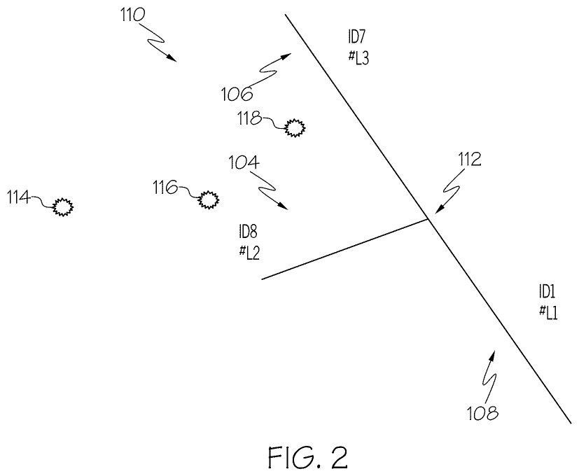

Referring now to FIG. 2, an example map 110 of the intersection 112 illustrated by FIG. 1 is provided. The first road 104, the second road 106 and the third road 108 are represented by road segments (i.e., lines) that meet at the intersection 112. In the illustrated embodiment, each road segment of the map 110 includes lane information in the form of an identification number (ID) and the number of lanes for each road segment. The first road 104 has an ID of 8 and two lanes, the second road 106 has an ID of 7 and three lanes, and the third road 108 has an ID of 1 and one lane.

As the vehicle 102 traverses the first road 104, it receives a plurality of GNSS signals providing a plurality of GNSS locations. As shown in FIG. 2, the vehicle 102 generated a first GNSS location 114 from a first GNSS signal, a second GNSS location 116 from a second GNSS signal, and a third GNSS location 118 from a third GNSS signal. These GNSS locations are generated sequentially over time as the vehicle 102 travels.

None of the GNSS locations shown in FIG. 2 are directly positioned on a road. Accordingly, the confidence of localizing the vehicle 102 on any of the first road 104, the second road 106 and the third road 108 is low. The GNSS signals may provide an accuracy of 20 m or higher, for example. In such a scenario, each GNSS location could be associated with any one of the first road 104, the second road 106 and the third road 108; however, there is not enough information for the vehicle 102 to be localized on the correct road in the map 110.

Referring now to FIG. 3, an example vehicle 102 is illustrated. The vehicle 102 may be a manually driven vehicle (i.e., a human-operated vehicle), a semi-autonomous vehicle having some autonomous functions (e.g., Level 2 autonomous vehicle), a fully autonomous vehicle (e.g., Level 5 autonomous vehicle), and the like. The example vehicle 102 includes a plurality of sensors 152, which may be cameras, proximity sensors, lidar sensors, radar sensors, wheel encoders, and combinations thereof. The sensors 152 produce sensor data regarding the environment, such as roads. In some embodiments, the sensor data includes video data generated from camera sensors. In some embodiments, the video data includes images of the road such that the vehicle 102 can determine the number of lanes of the road it is traveling on. The vehicle 102 includes one or more processors 150 that are configured to receive the sensor data (e.g., video and/or image data of the road) and detect the number of lanes. The vehicle 102 may, using the one or more processors 150, create a local map of the road that the vehicle 102 is traveling on that includes the number of lanes.

The vehicle further includes a GNSS device 154, such as a GPS receiver, that receives GNSS signals from satellites and stores, in a memory device, the GNSS locations of the GNSS signals.

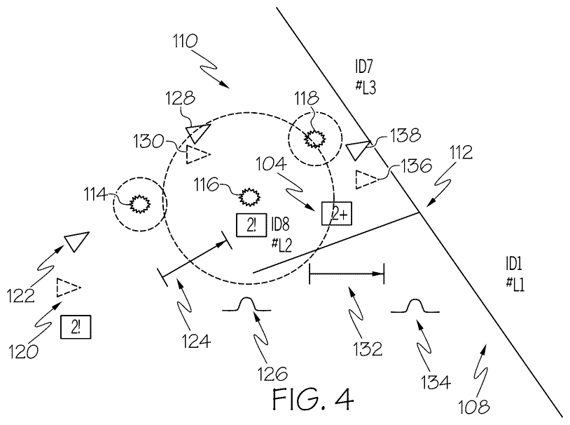

In embodiments of the present disclosure, the vehicle 102 uses probability information from sensor data to more accurately locate the vehicle on a map 110, such as an enhanced SD map. Referring now to FIG. 4, each GNSS location has a location uncertainty associated therewith. The location uncertainty may have a Gaussian distribution, for example. In FIG. 4, the confidence ellipse represents how noisy the GNSS signal is for each GNSS location. More specifically, the ellipse represents potential locations of the GNSS signal meeting a confidence score threshold. For example, the confidence score threshold may be 95% such that it is with 95% certainty that the true location of the GNSS signal is within the ellipse. The larger the ellipse, the more noisy the GNSS signal. The ellipse associated with the second GNSS location 116 is larger than the ellipse associated with the first GNSS location 114, and is thus noisier. For example, the radius of the ellipse of the first GNSS location 114 may be 5 m while the radius of the ellipse of the second GNSS location 116 may be 10 m.

Each GNSS location also has odometry data and resulting odometry uncertainty associated therewith. In FIG. 4, the odometry data is in the form of distance and heading. The sensors 152 of the vehicle 102 providing the odometry data may produce some error and therefore also be noisy. Such sensors may include wheel speed sensors or encoders that produce a signal as to the a heading an distance component from one timestamp to the next. A vehicle sensor 152 may produce a first heading reading 120 while the first actual heading 122 is slightly different, as represented by the direction of the arrows in FIG. 4. Similarly, the vehicle sensor 152 may produce a second heading reading 128 that is slightly different from a second actual heading 130, and the vehicle sensor 152 may produce a third heading reading 136 that is slightly different than a third actual heading 138, all of which contribute to the overall error as the vehicle 102 travels. It is noted that the heading measures are relative, and not absolute in a geodetic sense. That is, the odometry data only tells how the vehicle moves relative to a previous pose. It does not tell where the vehicle is located with respect to an extrinsic coordinate system, for example the center of the Earth.

Similarly, a sensor 152 may provide a signal indicative of the distance traveled between GNSS locations that are received, such as a first distance 124 and a second distance 132. These distances may also have error due to the sensor used to determine them.

The error of the sensors 152 used to produce the odometry data provide a Gaussian odometry uncertainty distribution. FIG. 4 illustrates a first odometry uncertainty 126 associated with the first heading reading 120 and the first distance 124 and a second odometry uncertainty 134 associated with the second heading reading 128 and the second distance 132. It is noted that odometry is typtically represented as a coordinate transformation in 2D or 3D. This coordinate transformation is comprised of a translational and a rotational component. Coordinate transformations can be accompanied by uncertainty/covariance matrices that capture motion noise in all degrees of freedom. These covariance matrices are usually identified in a calibration procedure, for example by comparing the reported odometry signal to a ground-truth odometry signal.

In some embodiments, a local map is generated at each GNSS location. The local maps are generated by using data of one or more vehicle sensors 152. As a non-limiting example, the vehicle sensors 152 include camera sensors that detect the road surface, including lane lines. Using the data provided by the camera sensors, the number of lanes of the road can be determined with some confidence. Thus, the local map for each GNSS location includes a local map number of lanes. In the example provided by FIG. 4, local maps associated with the first GNSS location 114 and the second GNSS location 116 indicate that there are exactly two lanes as indicated by the text “2!” proximate the two GNSS locations. However, the local map associated with the third GNSS location 118 indicates that there are at least two lanes as indicated by the text “2+”. The number of lanes of the local map may be created by a neural network that receives the image data of the camera sensors and produces an output with a particular confidence score. Thus, the vehicle 102 may also produce local lane probabilities for each local map that is generated as the vehicle 102 traverses the environment.

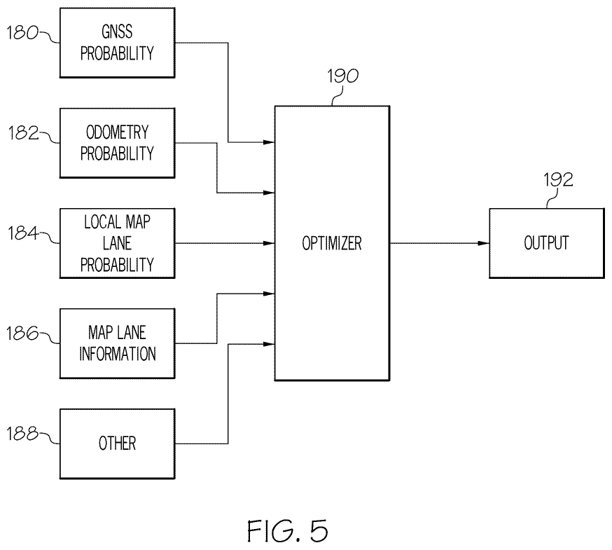

In embodiments of the present disclosure, various probabilities are provided as input to an optimizer, such as a quadratic programming module, which then fits a location of the vehicle at each GNSS location to establish a trajectory of the vehicle. FIG. 5 illustrates an example workflow of establishing a trajectory of a vehicle 102. On the right of FIG. 5, various measurements with various uncertainties are provided as input to an optimizer 190. Embodiments are not limited by the probabilities shown in FIG. 5, and more or fewer probabilities may be used as input. In the illustrated example, GNSS probability 180, odometry uncertainty 182, local map lane count 184 are provided as inputs to the optimizer 190. These probabilities may be generated based on the description above. Additional constraints may also be provided as inputs to the optimizer. In the illustrated example, map lane information 186 in the form of the number of lanes provided by the map 110 is used as a constraint by the optimization process of the optimizer 190. Further, other information 188 may also be provided as input into the optimizer 190. The other information 188 may include additional features, such as road surface type as detected by the camera data and provided within the local maps, as well as speed limit, lane width, and other road features.

The optimizer 190 includes a quadratic optimization module that optimizes the position of the vehicle 102 based on the various sensor measurements and their uncertainty values to produce an accurate trajectory as an output 192. The optimizer 190 receives the various probabilities and other constraints and optimizes the location of the vehicle by any known or yet-to-be-developed quadratic optimization technique. Non-limiting examples include the Gauss-Newton algorithm, gradient descent, and direct search.

In some embodiments, the optimizer 190 may include mixed-integer programming techniques. A mixed-integer approach enables the optimizer to iterate over different vehicle-road associations. As a consequence, it returns a maximum-likelihood trajectory that is optimal in the sense that it not only maximizes the measurement likelihood given fixed associations between the vehicle and the closest road, for example, but that it maximizes the likelihood over all vehicle locations and vehicle-road associations.

The optimizer 190 is thus able to output accurate locations of the vehicle that can be then used to generate an accurate trajectory that the vehicle 102 took within the environment. The optimizer 190 may operate in an offline mode where the vehicle 102 generates and stores the sensor data, and trajectories are created after the driving session using the stored sensor data. This may be helpful in building maps, or analyzing fleet data of a fleet of vehicles, as non-limiting examples.

The optimizer 190 may also be used in an online mode where trajectories are generated within a sliding window while the vehicle is driving. For example, a trajectory that the vehicle took may be continuously generated over a time period, such as 60 seconds as a non-limiting example. Accordingly, the GNSS probabilities, the odometry probabilities, and any other data may be inputted into the optimizer 190 to generate vehicle locations and trajectories within a window, such that vehicle locations outside of the window are deleted or otherwise forgotten. An autonomous driving software stack and associated hardware may use this real-time trajectory provided by the optimizer 190 to produce vehicle control signals to operate the vehicle 102 such that it autonomously navigates the environment. The increased accuracy of the vehicle locations and trajectories developed by the methods described herein enables the autonomous vehicle 102 to more accurately navigate the environment without human control.

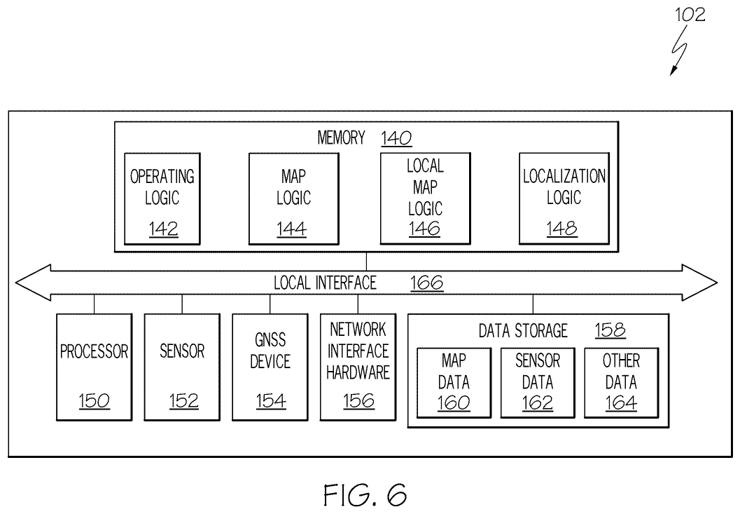

Referring now to FIG. 6, an example system of a vehicle 102 for localizing the vehicle 102 on a map is schematically illustrated. It is noted that some or all of the components of FIG. 6 may be provided as a computing apparatus that is separate from the vehicle 102. The example vehicle 102 provides a system for localizing a vehicle 102 on a map, and/or a non-transitory computer usable medium having computer readable program code for localizing a vehicle 102 on a map embodied as hardware, software, and/or firmware, according to embodiments shown and described herein. It should be understood that the software, hardware, and/or firmware components depicted in FIG. 6 may also be provided in other computing devices external to the vehicle 102 (e.g., data storage devices, remote server computing devices, and the like).

As also illustrated in FIG. 6, the vehicle 102 (or other additional computing devices) may include a processor 150, one or more sensors 152, one or more GNSS devices 154, network interface hardware 156, and a data storage component 158 (which may store map data 160, sensor data 162, and any other data 164 for performing the functionalities described herein), and a non-transitory memory component 140. The non-transitory memory component 140 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. In other embodiments, the memory component 140 may be defined by transitory memory and/or signals.

Additionally, the memory component 140 may be configured to store operating logic 142, map logic 144 for rendering map data 160, local map logic 146 for receiving sensor data and GNSS signals, and generating local maps for GNSS locations, and localization logic 148 for localizing the vehicle on the map using an optimizer 190 (each of which may be embodied as computer readable program code, firmware, or hardware, as an example). It should be understood that the data storage component 158 may reside local to and/or remote from the vehicle 102, and may be configured to store one or more pieces of data for access by the vehicle 102 and/or other components.

A local interface 166 is also included in FIG. 6 and may be implemented as a bus or other interface to facilitate communication among the components of the vehicle 102.

The processor 150 may include any processing component configured to receive and execute computer readable code instructions (such as from the data storage component 158 and/or memory component 140). The network interface hardware local interface 166 may include any wired or wireless networking hardware, such as a modem, LAN port, wireless fidelity (Wi-Fi) card, WiMax card, mobile communications hardware, and/or other hardware for communicating with other networks and/or devices.

Included in the non-transitory memory component 140 may be the operating logic 142, map logic 144, local map logic 146, and localization logic 148. The operating logic 142 may include an operating system and/or other software for managing components of the vehicle 102 or a computing apparatus. The map logic 144 may reside in the memory component 140 and may be configured to receive map data 160 and render or otherwise generate a map (e.g., a map used by autonomous functions of the vehicle and/or display on a display device within the vehicle 102). The local map logic 146 also may reside in the memory component 140 and may be configured to receive sensor data 162 and GNSS signals, generate GNSS locations, and generate a local map for each of the GNSS locations based on the sensor data 162. The localization logic 148 includes the optimizer 190 logic and is configured to analyze the map data 160, generate probabilities (e.g., location probabilities and odometry probabilities) and the local maps of the GNSS locations, to localize the vehicle 102 on the map, and to generate a trajectory using an optimization method.

It should be understood that the components illustrated in FIG. 6 are merely exemplary and are not intended to limit the scope of this disclosure. More specifically, while the components in FIG. 6 are illustrated as residing within the vehicle 102, this is a non-limiting example. In some embodiments, one or more of the components may reside external to the vehicle 102.

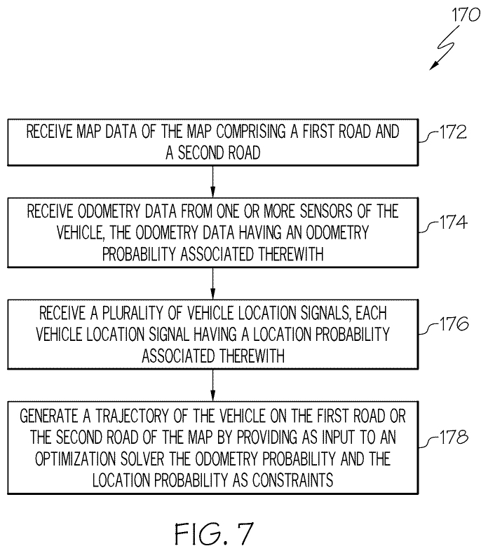

FIG. 7 is a flowchart illustrating an example method 170 for generating a trajectory of a vehicle. It is noted that the blocks of the flowchart are repeated over and over as the vehicle navigates the environment. In block 172, the method 170 includes receiving map data of a map comprising a first road and a second road, as well as road attributes such as lane counts for the first road and the second road. In block 174, the method 170 further includes receiving odometry data from one or more sensors of the vehicle, wherein the odometry data has an odometry uncertainty associated therewith. In block 176, the method 170 receives a plurality of vehicle location signals, wherein each vehicle location signal has a location uncertainty associated therewith. Next, in block 178, the method 170 includes localizes the vehicle on the first road or the second road of the map by providing as input to an optimization solver the odometry uncertainty and the location uncertainty as constraints.

It should now be understood that embodiments of the present disclosure are directed to systems and methods for increasing the accuracy of determining vehicle trajectories by using the probabilities associated with sensor data as inputs to an optimization solver programmed to develop a trajectory that the vehicle takes on a map, such as an enhanced SD map.

The location uncertainty and odometry uncertainty (as well as additional information in some cases) are provided as inputs into an optimizer as constraints that outputs an accurate trajectory of the vehicle. The outputted trajectory may be used in an offline process to map the route a vehicle took during a driving session, or used by an autonomous vehicle to autonomously navigate the environment in an on-line process.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of generating a trajectory of a vehicle on a map, the method comprising:
receiving map data of the map comprising a first road and a second road;
receiving odometry data from at least a first sensor of one or more sensors of the vehicle, the odometry data having an odometry uncertainty associated therewith;
receiving a plurality of vehicle location signals associated with, respectively, a plurality of location uncertainties;
determining a plurality of local lane probabilities associated with, respectively, the plurality of vehicle location signals, each local lane probability of the plurality of local lane probabilities being associated with a respective local map of a plurality of local maps generated for, respectively, the plurality of vehicle location signals;
generating the trajectory of the vehicle on the first road or the second road of the map by providing as input to an optimizer the odometry uncertainty, the plurality of location uncertainties, and the plurality of local lane probabilities;
generating one or more vehicle control signals based on the trajectory; and
controlling an autonomous operation of the vehicle based on the one or more vehicle control signals.

2. The method of claim 1, wherein the first road of the map has a first number of lanes and the second road of the map has a second number of lanes.

3. The method of claim 2, further comprising:
receiving sensor data at least a second sensor from the one or more sensors of the vehicle;
generating, from the sensor data, a local map of the plurality of local maps, the local map comprising a local map number of lanes for a respective vehicle location signal of the plurality of vehicle location signals; and
providing as the input to the optimizer the local map number of lanes for the respective vehicle location signal.

4. The method of claim 3, further comprising providing as the input to the optimizer the first number of lanes and the second number of lanes.

5. The method of claim 1, wherein the plurality of vehicle location signals comprise a plurality of global navigation satellite system (GNSS) signals.

6. The method of claim 1, wherein the vehicle is localized on the map for each vehicle location signal of the plurality of vehicle location signals.

7. A vehicle, comprising:
one or more processors;
one or more sensors; and
a non-transitory memory storing instructions that, when executed by the one or more processors, configure the vehicle to:
receive map data of a map comprising a first road and a second road;
receive odometry data from at least a first sensor of the one or more sensors, the odometry data having an odometry uncertainty associated therewith;
receive a plurality of vehicle location signals associated with, respectively, a plurality of location uncertainties;
determine a plurality of local lane probabilities associated with, respectively, the plurality of vehicle location signals, each local lane probability of the plurality of local lane probabilities being associated with a respective local map of a plurality of local maps generated for, respectively, the plurality of vehicle location signals;
generate a trajectory of the vehicle on the first road or the second road of the map by providing as input to an optimizer the odometry uncertainty, the plurality of location uncertainties, and the plurality of local lane probabilities;
generate one or more vehicle control signals based on the trajectory; and
control an autonomous operation of the vehicle based on the one or more vehicle control signals.

8. The vehicle of claim 7, wherein the first road of the map has a first number of lanes and the second road of the map has a second number of lanes.

9. The vehicle of claim 8, wherein the instructions further configure the vehicle to:
receive sensor data from at least a second sensor of the one or more sensors of the vehicle;
generate, from the sensor data, a local map of the plurality of local maps, the local map comprising a local map number of lanes for a respective vehicle location signal of the plurality of vehicle location signals; and
provide as the input to the optimizer the local map number of lanes for the respective vehicle location signal.

10. The vehicle of claim 9, wherein the instructions further configure the vehicle to provide as the input to the optimizer the first number of lanes and the second number of lanes.

11. The vehicle of claim 7, wherein the plurality of vehicle location signals comprise a plurality of global navigation satellite system (GNSS) signals.

12. The vehicle of claim 7, wherein the vehicle is localized on the map for each vehicle location signal of the plurality of vehicle location signals.

13. The vehicle of claim 7, wherein the instructions further configure the vehicle to autonomously navigate based at least in part on localization of the vehicle on the map.

14. A computing apparatus, comprising:
one or more processors; and
a non-transitory memory storing instructions that, when executed by the one or more processors, configure the computing apparatus to:
receive map data of a map comprising a first road and a second road;
receive odometry data from at least a first sensor of one or more sensors of a vehicle, the odometry data having an odometry uncertainty associated therewith;
receive a plurality of vehicle location signals associated with, respectively, a plurality of location uncertainties;
determine a plurality of local lane probabilities associated with, respectively, the plurality of vehicle location signals, each local lane probability of the plurality of local lane probabilities being associated with a respective local map of a plurality of local maps generated for, respectively, the plurality of vehicle location signals;
generate a trajectory of the vehicle on the first road or the second road of the map by providing as input to an optimizer the odometry uncertainty, the plurality of location uncertainties, and the plurality of local lane probabilities;
generate one or more vehicle control signals based on the trajectory; and
control an autonomous operation of the vehicle based on the one or more vehicle control signals.

15. The computing apparatus of claim 14, wherein the first road of the map has a first number of lanes and the second road of the map has a second number of lanes.

16. The computing apparatus of claim 15, wherein the instructions further configure the computing apparatus to:
receive sensor data from at least a second sensor of the one or more sensors of the vehicle;
generate, from the sensor data, a local map of the plurality of local maps, the local map comprising a local map number of lanes for a respective vehicle location signal of the plurality of vehicle location signals; and
provide as the input to the optimizer the local map number of lanes for the respective vehicle location signal.

17. The computing apparatus of claim 16, wherein the instructions further configure the computing apparatus to provide as the input to the optimizer the first number of lanes and the second number of lanes as constraints.

18. The computing apparatus of claim 14, wherein the plurality of vehicle location a plurality of global navigation satellite system (GNSS) signals.

19. The computing apparatus of claim 14, wherein the vehicle is localized on the map for each vehicle location signal of the plurality of vehicle location signals.

20. The computing apparatus of claim 14, wherein the map is an enhanced standard definition map.
